(19) United States
(12) Patent Application Publication
(10) Pub. No.: US 2001/0042997 A1
(43) Pub. Date: Nov. 22, 2001

(54) Aluminum trailer

(76) Inventor: Douglas A. Newman, Royalton, MN (US)

Correspondence Address: RIDER, BENNETT, EGAN & ARUNDEL, 333 SOUTH SEVENTH STREET, SUITE 2000, MINNEAPOLIS, MN, 55402, US

(21) Appl. No.: 09/827,818

(22) Filed: Apr. 6, 2001

Related U.S. Application Data
(60) Provisional application No. 60/195,698, filed on Apr. 7, 2000.

(51) Int. Cl. B60N 2/00

(52) U.S. Cl. 296/181

(57) ABSTRACT

A trailer with a box constructed of horizontal and vertical rails. Each of the rails is made of extruded aluminum. The horizontal rails have aligned openings through which the vertical rails pass, rather than having the vertical rails attached to the external surfaces of the horizontal rails. This construction provides added structural support.

### BACKGROUND OF THE INVENTION

The present invention relates to a trailer, and in particular to a trailer with a box constructed of sides and a gate with extruded aluminum rails that pass through other aluminum rails, providing superior structural support.

Most trailers, and aluminum trailers in particular, are constructed with a box having sides and a gate with rails that are attached to each other by bolts or screws. For those trailers with extruded aluminum rails, the prior practice has been for the vertical supports, or stakes, to be attached to the outside surface of the horizontal rails by bolts or screws.

### SUMMARY OF THE INVENTION

The present invention is a trailer with a box constructed of extruded aluminum rails. The sides and gates have horizontal rails with aligned openings through which the vertical supports, or stakes, pass, rather than being attached to the external surface of the horizontal rails.

Because the vertical support rails pass through the interior of the horizontal rails, the box and gate of the trailer have much better structural support than in earlier trailers.

### BRIEF DESCRIPTION OF THE DRAWINGS

FIG. 1 is a perspective view of the trailer of the present invention;

FIG. 2 is a top plan view of the trailer of the present invention;

FIG. 3 is a right side elevational view of the trailer of the present invention;

FIG. 4 is a perspective view of the front rail of the trailer of the present invention;

FIG. 5 is a front elevational view of the front rail of the trailer of the present invention;

FIG. 6 is a perspective view of the top side rail of the trailer of the present invention;

FIG. 7 is a perspective view of the middle side rail of the trailer of the present invention;

FIG. 8 is a perspective view of the ramp of the trailer of the present invention;

FIG. 9 is s rear elevational view of the ramp of the trailer of the present invention;

FIG. 10 is a perspective view of a ramp cross-member of the trailer of the present invention;

FIG. 11 is a perspective view of the end rail of the ramp of the trailer of the present invention; and

FIG. 12 is a perspective view of an upright of the trailer of the present invention.

### DETAILED DESCRIPTION OF THE PREFERRED EMBODIMENT

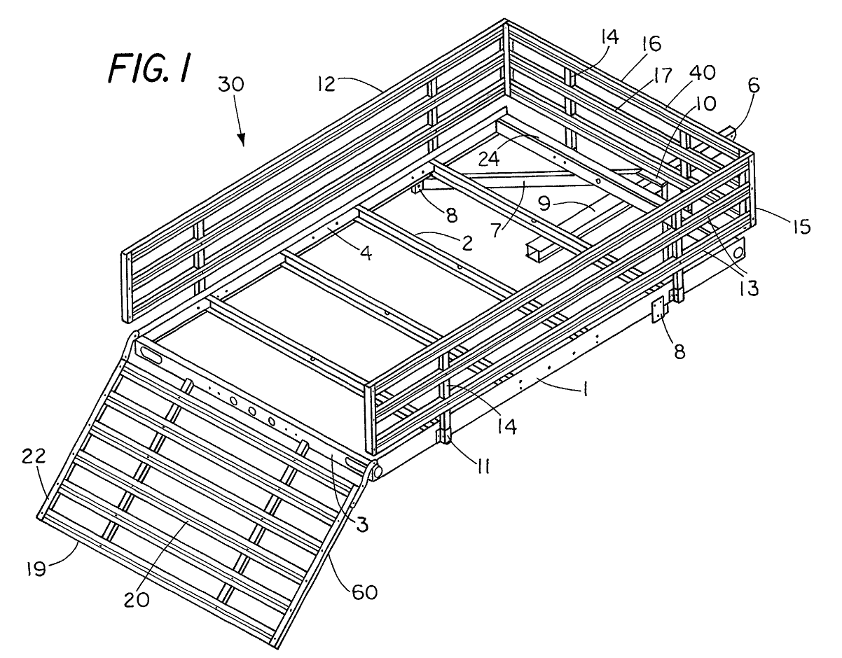

The trailer 30 of the present invention is shown in FIG. 1. The trailer 30 has right side frame 1, intermediate cross members 2, rear cross member 3, left side frame 4, frame end plates 5, tongue 6, A frame arms 7, A Frame end plates 8, tongue guide 9, tongue A frame plate 10, stake pockets 11, top rail side racks 12, lower rail side racks 13, stakes 14, end caps for racks 15, top rail end racks 16, lower rail end racks 17, end rack intermediate stake 18, ramp bottom rail 19, ramp intermediate rails 20, ramp stringer 21, ramp end caps 22, tongue angle clip 23, front cross member 24, and ramp pivot 25.

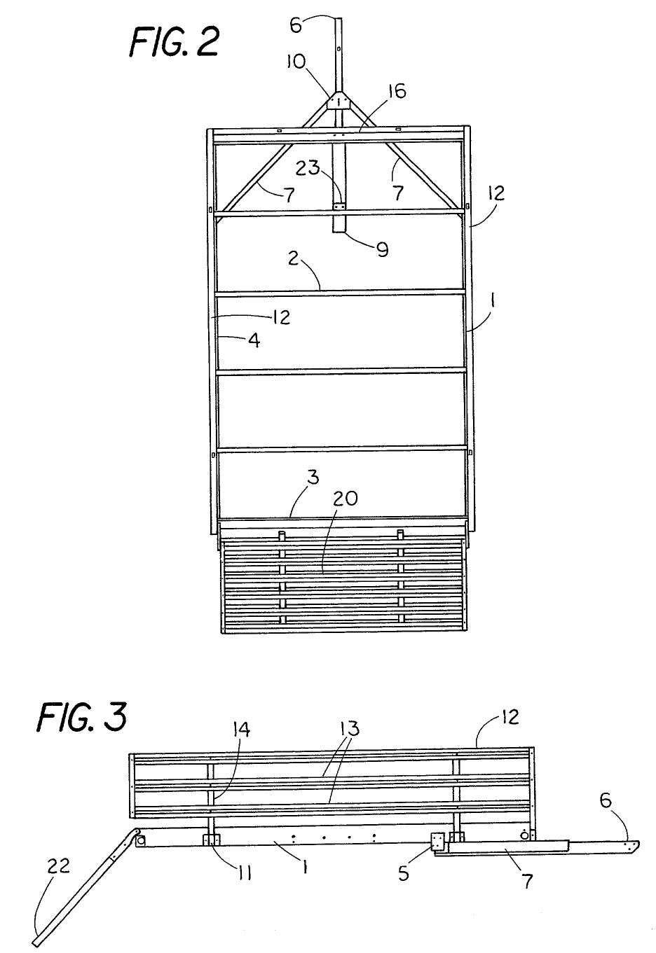

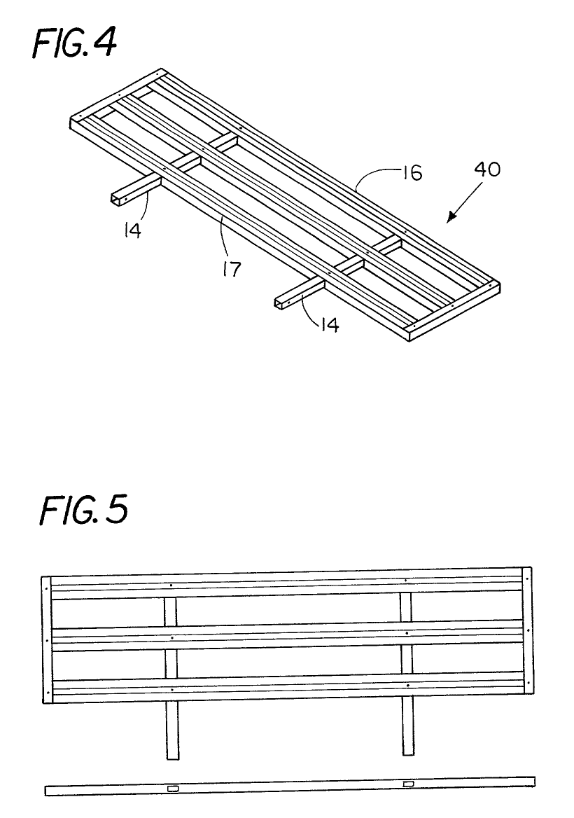

As best seen in FIG. 2, the front rail 40 has top rail end racks 16 and lower rail end racks 17. Stakes 14 traverse the top rail end racks 16 and lower rail end racks 17, passing through the interior of the top rail end racks 16 and lower rail end racks 17.

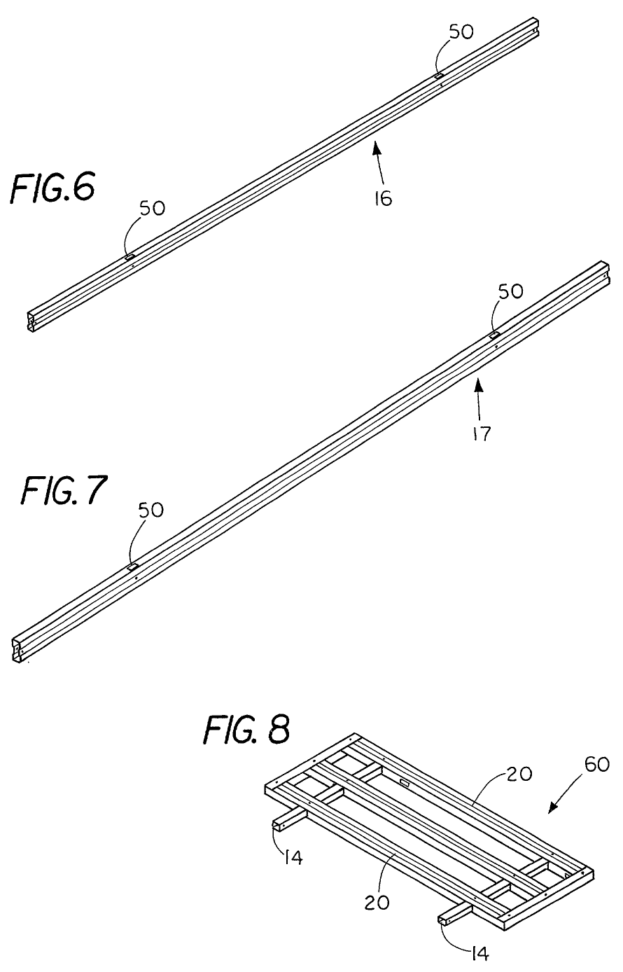

As best seen in FIG. 6, the top rail 16 has openings 50 through which the stakes 14 pass. The middle rails 17 also have openings 50 for the stakes 14.

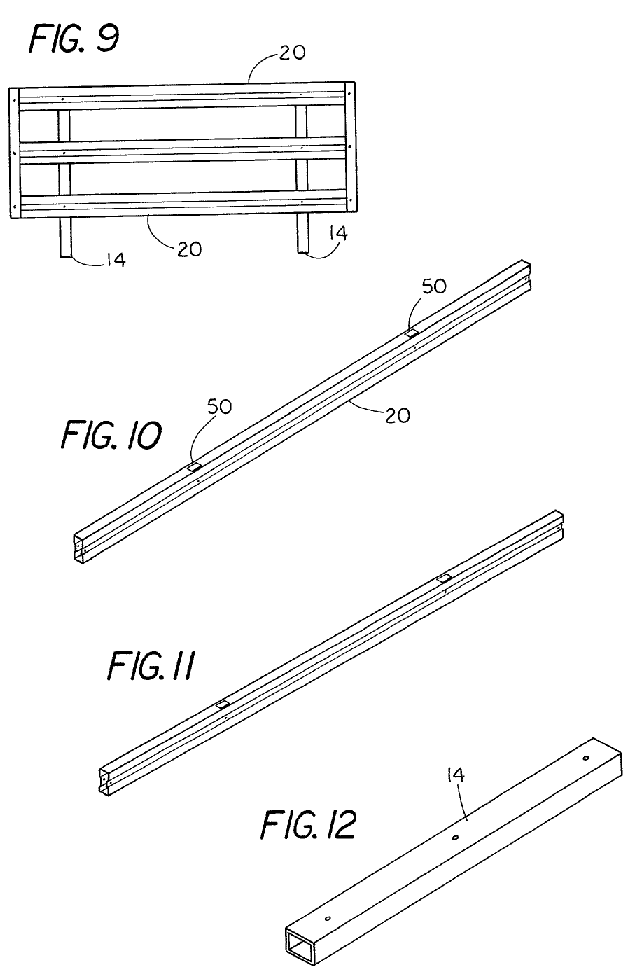

As best seen in FIGS. 9 and 10, the ramp 60 has rails 20 through which the stakes 14 pass. The rails 20 have openings 50 for the stakes 14, as best seen in FIGS. 10 and 11.

A typical stake 14 used for all the rails is shown in FIG. 12.

The present invention may be embodied in other specific forms without departing from the spirit or essential attributes thereof, and it is therefore desired that the present embodiment be considered in all respects as illustrative and not restrictive.

What is claimed:

1. A trailer having a box constructed of three sides and a pivoting gate, each of the sides and the gate further comprising a plurality of substantially horizontal rails, each of the substantially horizontal rails having an opening substantially vertically therethrough, and further comprising a plurality of substantially vertical rails passing through the openings

2. The trailer of claim 1, each of the substantially horizontal rails and each of the substantially vertical rails being constructed of extruded aluminum.
